(19) United States
(12) Patent Application Publication
(10) Pub. No.: US 2004/0126189 A1
(43) Pub. Date: Jul. 1, 2004

(54) Method for stabilizing chromium-contaminated materials

(76) Inventor: Ajit K. Chowdhury, Madison, WI (US)

Correspondence Address: Bennett J. Berson, Quarles & Brady LLP, P.O. Box 2113, Madison, WI, 53701-2113, US

(21) Appl. No.: 10/624,826

(22) Filed: Jul. 22, 2003

Related U.S. Application Data
(63) Continuation-in-part of application No. 09/892,257, filed on Jun. 27, 2001, now Pat. No. 6,607,474.

(51) Int. Cl. B09C 1/08; G21F 9/00; A62D 3/00; B01D 1/00; C02F 7/00

(52) U.S. Cl. 405/128.5; 588/256; 405/129.3; 210/747

(57) ABSTRACT

A cost-effective, long-term, permanent method for stabilizing chromium in a chromium-contaminated waste matrix characterized by high concentrations of alkaline material (such as lime) includes the steps of contacting a source of hexavalent chromium with a source of ferrous ions to produce ferric ions; oxidizing iron pyrite to produce ferrous sulfate and sulfuric acid; and contacting the alkaline chromium-contaminated particulate matter with the ferrous sulfate and the sulfuric acid for a time sufficient to convert ferrous sulfate into ferric sulfate and to reduce mobile hexavalent chromium to non-leachable trivalent chromium. The method is integrated in that ferrous sulfate produced by oxidizing iron pyrite serves as a source of ferrous ions in the first contacting step. Optionally, ferric ions can be generated in a side reactor and then used to produce ferrous ions. The ferrous ions can be used both to produce further ferric ions in the side reactor and to treat COPR waste.

### CROSS-REFERENCE TO RELATED APPLICATIONS

This application is a Continuation-in-Part of copending U.S. application Ser. No. 09/892,257, filed Jun. 27, 2001.

### STATEMENT REGARDING FEDERALLY SPONSORED RESEARCH OR DEVELOPMENT

Not applicable.

### BACKGROUND OF THE INVENTION

The present invention relates to methods for reducing the leaching potential of environmental chromium-contaminated particulate matter to acceptable levels. More particularly, this invention describes methods for stabilizing hexavalent chromium in chromium-contaminated materials.

In the environment, chromium exists predominantly in two forms—hexavalent chromium and trivalent chromium. Trivalent chromium is significantly more stable than hexavalent chromium, which is highly mobile. It is known that a near-neutral pH is required to keep trivalent chromium in a stable, insoluble state. Hexavalent chromium is a known human carcinogen, a RCRA hazardous material, and a common contaminant on the Comprehensive Environmental Response, Compensation, and Liability Act (CERCLA) Priority List of Hazardous Substances. Although chromium metal, like other metals, exhibits a positive valence state, hexavalent chromium is typically present in the environment as an oxy-anion such as chromate (CrO₄²⁻) or dichromate (Cr₂O₇²⁻). As a result, technologies that effectively treat other cationic metals do not effectively stabilize chromium. The oxidation state of chromium, the oxidation-reduction potential (ORP) and the pH of the waste material are key parameters for controlling the leaching potential of chromium in the environment.

Reducing agents such as ferrous sulfate can stabilize hexavalent chromium in some environments. However, in alkaline environments, ordinary ferrous sulfate treatment of certain chromium-bearing wastes, including chromium ore processing residue (COPR), reduces chromium leachability for only a short time after treatment. Over time, the pH of the waste matrix slowly rises due to the high alkaline (e.g., lime) content, and chromium again leaches from the waste.

Other known approaches for stabilizing alkaline COPR have included reduction with manganese nitrate, lactic acid, steel wool, or hardwood tree leaf litter (James, B. R., Hexavalent Chromium Solubility and Reduction in Alkaline Soils Enriched with Chromite Ore Processing Residue, J. Environ. Qual. 22:227-233 (1994)), reduction with sulfide ions (U.S. Pat. No. 3,981,965), adjustment of pH followed by the addition of organic material (U.S. Pat. No. 5,562,588), mixing with mud or dredged sediment and ground blast furnace slag (U.S. Pat. No. 4,504,321), in situ treatment with the addition of ferrous sulfate (U.S. Pat. No. 5,202,033), treatment with ferrous iron followed by the addition of silicate solution (U.S. Pat. No. 5,285,000), and treatment with ascorbic acid (U.S. Pat. No. 5,951,457).

It is known that simultaneous combination of a pH control agent and an agent for controlling oxidation-reduction potential (ORP) with chromium-contaminated waste can reduce hexavalent chromium to the less mobile trivalent state. A combination of sulfuric acid for pH control and ferrous sulfate for ORP control has been used for this purpose, as have hydrochloric acid and iron chloride, respectively. A convenient source of these agents is “pickle liquor” from sulfuric acid-based or hydrochloric acid-based metal processing/finishing operations. Alternatively, FeSO₄ and H₂SO₄ are known to be generated by controlled oxidation of iron pyrite (FeS₂).

Cost-effective, permanent stabilizing of alkaline chromium-contaminated particulate matter has not been achieved, in part as a result of a need to convey large quantities of reactants to a stabilization site.

### BRIEF SUMMARY OF THE INVENTION

The present invention is summarized in that an improved process for stabilizing chromium-contaminated particulate matter and reducing chromium leaching to acceptable levels integrates previously separate processes for (1) preparing the ferrous sulfate and sulfuric acid reactants and (2) using byproducts of the stabilization process to produce additional reactants, thereby reducing or eliminating dependence upon external reactant sources.

A major objective of the invention is cost-effective, long-term, permanent stabilization of chromium in a chromium-contaminated waste matrix characterized by high concentrations of alkaline material (such as lime), where the waste can contain both trivalent and hexavalent chromium.

In the integrated process of the present invention, ferrous sulfate and sulfuric acid are used to stabilize hexavalent chromium in an alkaline environment. Iron pyrite is oxidized to produce the ferrous sulfate and sulfuric acid. The iron pyrite can be oxidized by treating it with soluble ferric ions, preferably provided as a ferric salt, such as ferric sulfate, which can itself be produced as a byproduct of a reduction process wherein ferrous sulfate is used to reduce hexavalent chromium to trivalent chromium. Other pyrite oxidation means are also disclosed.

The invention will be understood by referring to the detailed description of the invention, read in conjunction with the accompanying drawings.

### BRIEF DESCRIPTION OF THE DRAWINGS

FIG. 1 depicts an in situ system for stabilizing chromium in a chromium-contaminated material wherein a ferric salt is produced by reducing chromium from contaminated groundwater using a source of ferrous ions. The ferric salt, in turn, can oxidize iron pyrite to produce ferrous sulfate and sulfuric acid. The latter compounds are in fluid communication with the chromium-contaminated material and can stabilize the chromium in its trivalent form. In addition, ferrous ions produced in the oxidation of iron pyrite can be further oxidized to a ferric salt by mixing the ferrous ions with contaminated groundwater, whereupon the integrated oxidation-reduction process can continue. Additional ferrous ions (chemical 2) or ferric salt (chemical 3) can be added if needed.

FIG. 2 depicts a variation on the in situ system of FIG. 1, wherein the chromium-contaminated material is not in the groundwater. In this variant embodiment, water is passed through the chromium-contaminated material until a contaminated leachate is recovered and combined with ferrous ions, as above. Thereafter, the reactions proceed as shown in FIG. 1.

FIG. 3 depicts another variation on the in situ system of FIG. 1 wherein the iron pyrite is not provided on top of the chromium-contaminated matter, but rather is oxidized separately, though still in fluid communication with the chromium-contaminated matter.

FIG. 4 depicts yet another variation on the in situ system of FIG. 1 wherein a portion of the chromium-contaminated matter is provided on top of the pyrite layer. In this variation, ferric ions produced in treating the top layer of chromium-contaminated matter enter and promote oxidation of the iron pyrite layer. Further, ferrous ions produced in oxidizing the iron pyrite layer are recycled onto and react with the top layer of chromium-contaminated matter to produce additional ferric ions.

FIG. 5 depicts yet another variation on the in situ system of FIG. 1 wherein ferric ions are withdrawn from a treatment zone near the top of the chromium-contaminated matter and are delivered to the iron pyrite layer to further promote oxidation of the iron pyrite into ferrous sulfate and sulfuric acid.

FIG. 6 depicts still another embodiment of the in situ system of the invention wherein iron pyrite is injected at various depths of a waste column to create alternating iron pyrite and waste layers.

FIG. 7 depicts an embodiment of the invention in which ferric ions generated in a side reactor (trickling filter) are used to produce ferrous ions. The ferrous ions can be used both to produce further ferric ions in the side reactor and to treat COPR waste. Sample point arrows depict points at which one can monitor the composition of fluids in the treatment system. Optional pumps are shown at convenient pumping points in the system.

### DETAILED DESCRIPTION OF THE INVENTION

The present invention describes a cost effective, permanent process for stabilizing chromium-contaminated particulate matter in an alkaline waste matrix. The waste matrix can include alkaline chromium ore processing residue (COPR), chromium-contaminated soil, sediment, industrial waste, sludge, fill material, or any other particulate material. The method permanently reduces chromium leachability to levels below the TCLP toxicity threshold of 5 mg/L or below the threshold of any other site-specific leaching criteria, such as SPLP, ASTM water leach, etc.

In the process, an alkaline chromium-contaminated particulate waste matrix is contacted simultaneously with an amount of acid sufficient to substantially neutralize the alkali (lime) content and with an amount of a reducing agent sufficient to convert substantially all of the hexavalent chromium in the waste matrix to its trivalent form. Reducing the waste matrix pH to near neutral levels and converting the chromium into its trivalent form permanently stabilizes the waste and minimizes chromium leaching. The addition rate of the reducing agent and the pH control agent can be controlled to treat the COPR waste as well as any associated pore water and groundwater contaminated with hexavalent chromium in order to maintain a waste matrix pore water ORP and pH to minimize the leaching potential of chromium.

A preferred pH control agent for stabilizing alkaline chromium-contaminated particulate matter is sulfuric acid, and a preferred ORP control agent for reducing hexavalent chromium is ferrous sulfate. Ferrous sulfate may also function as a pH control agent. Commercially available sulfuric acid and ferrous sulfate may be used in the stabilization process. Alternatively, a convenient source of both sulfuric acid and ferrous sulfate is “pickle liquor,” as described above.

The chromium stabilization process may be used in situ or ex situ for disposed wastes, fill material, sediment, contaminated soil, etc., depending on specific site conditions. Although in situ treatment is not required in the method, it can offer significant advantages, especially when stabilizing highly alkaline chromium-contaminated wastes or where it is inconvenient to haul enormous quantities of acidic material to the site. This can be a major disadvantage for stabilization sites in urban areas.

The present invention desirably permits one to generate both the reducing agent and the acid on-site or in situ. For in situ stabilization, the treatment chemicals can be added to the top of a waste column and the waste will be stabilized as the chemicals flow down the waste column. This is accomplished in the present invention by controlled oxidation of iron pyrite according to the following simplified equation:

FeS₂+7/2O₂+H₂O→FeSO₄+H₂SO₄

Approximately 1.27 tons of ferrous sulfate and 0.82 ton of sulfuric acid may be produced by the oxidation of 1 ton of iron pyrite. This amount of ferrous sulfate is equivalent to approximately 12.7 tons, or one-half a truckload, of pickle liquor containing approximately 10 percent ferrous sulfate. Therefore, substantial transportation and material handling costs may be saved by generating the treatment chemical components on-site.

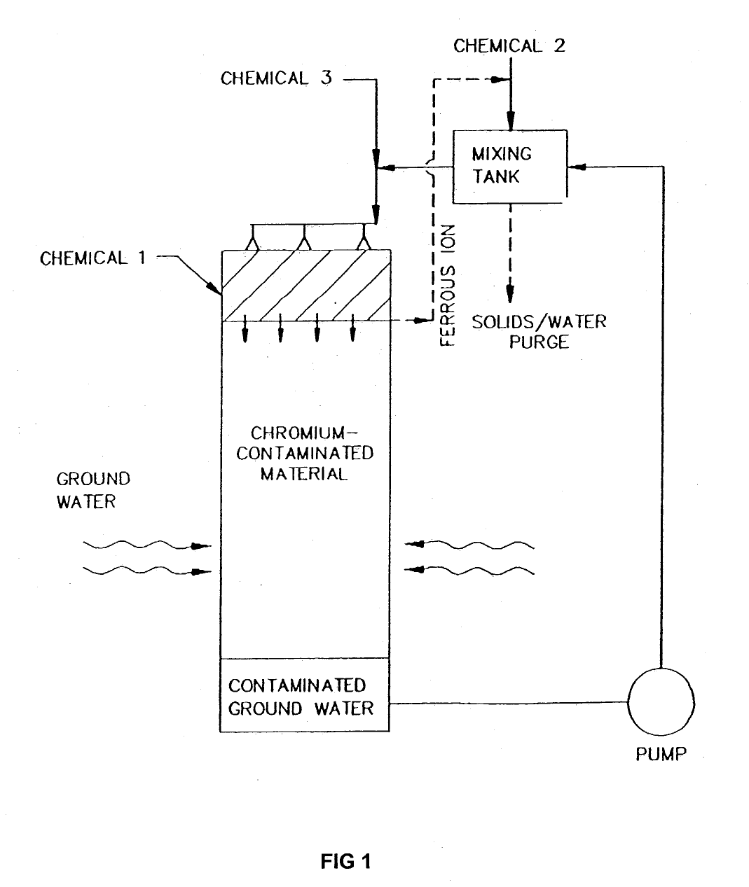

FIG. 1 depicts a simplified schematic depiction of a basic in situ stabilization plan for disposed alkaline chromium-contaminated waste with in situ generation of ferrous sulfate and sulfuric acid. In FIG. 1, the waste may be any alkaline chromium-contaminated particulate matter such as chromium ore processing residue (COPR) and the like.

Groundwater contaminated with hexavalent chromium is pumped to a mixing tank where it is brought into contact with ferrous sulfate (FeSO₄; chemical 2) or pickle liquor to reduce the chromium to its trivalent form. Ferrous sulfate is added to the mixing tank at a controlled rate to maintain recycle water pH in the acidic range. During this reduction process, ferrous iron is converted to ferric iron. Particulate solids are removed from the mixture and water containing ferric iron is recycled to the pyrite layer (identified as chemical 1) to catalyze iron pyrite oxidation. Additional ferric iron (chemical 3) can be added to the recycle water prior to contact with iron pyrite (chemical 1). Low pH of the recycle water along with ferric iron catalyzes iron pyrite oxidation and produces ferrous sulfate and sulfuric acid, which flows downward and stabilizes the underlying chromium-contaminated material. The rate of stabilization of the waste column can be controlled by controlling the flow rate, pH, and ferric iron concentration in the recycle water which in turn controls the oxidation of iron pyrite to ferrous sulfate and sulfuric acid.

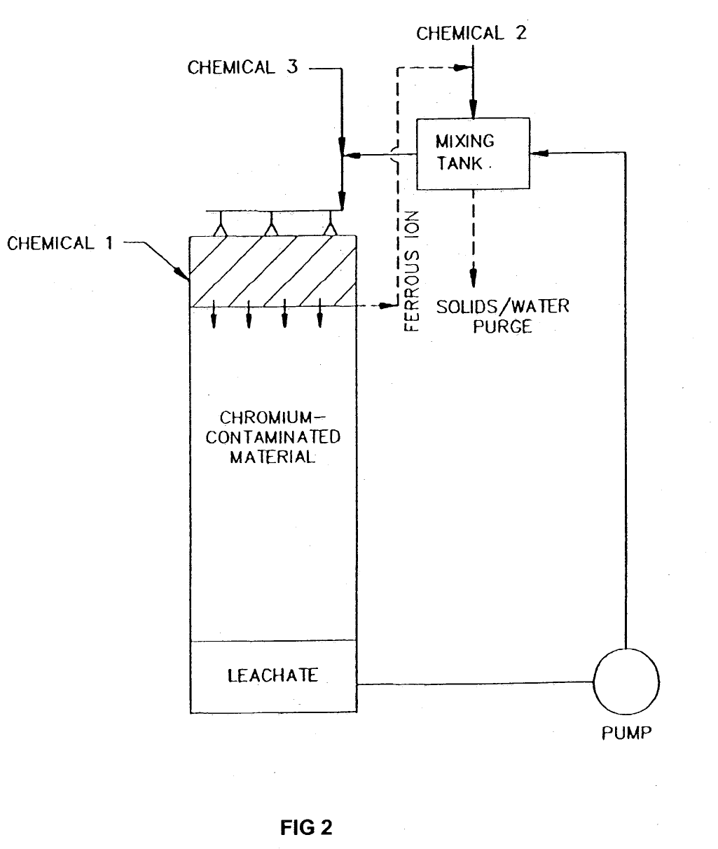

The treatment cycle continues until the groundwater pH is near neutral and contains hexavalent chromium at levels below a desired toxicity threshold. Where no groundwater is encountered, leachate generated from the waste column is recirculated in a similar manner, as is shown in FIG. 2.

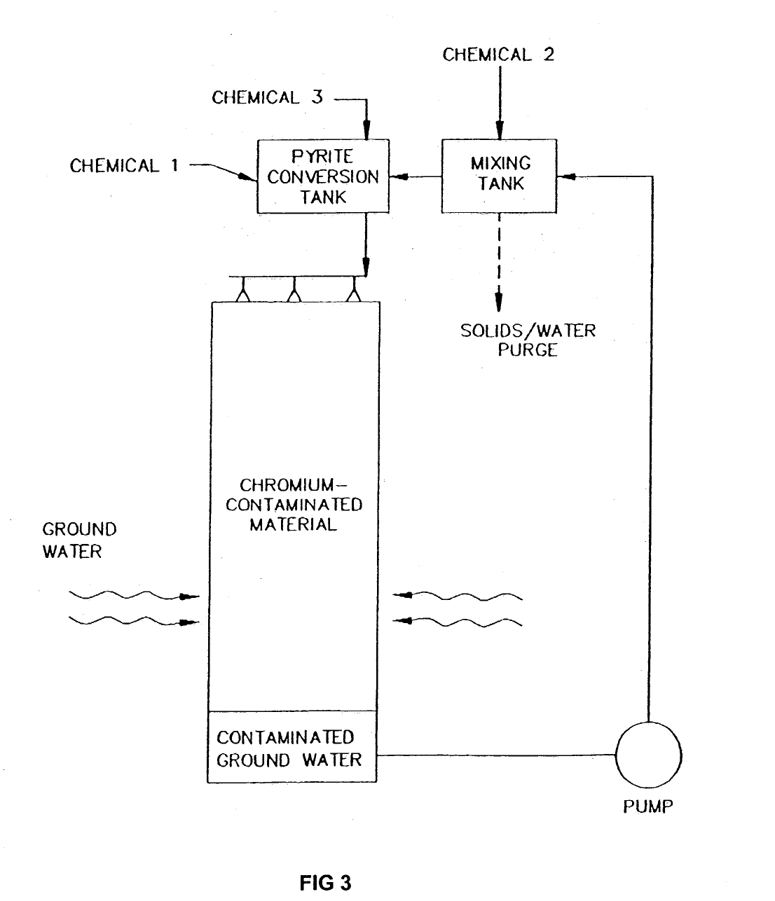

In a related embodiment, the iron pyrite can be oxidized ex situ using recycled contaminated groundwater (FIG. 3) or leachate to produce ferrous sulfate and sulfuric acid that can subsequently be added or injected to the chromium-contaminated waste as in the previous embodiments. Alternatively, the ex situ iron pyrite oxidation may be carried out by oxidation processes such as wet oxidation or wet air oxidation.

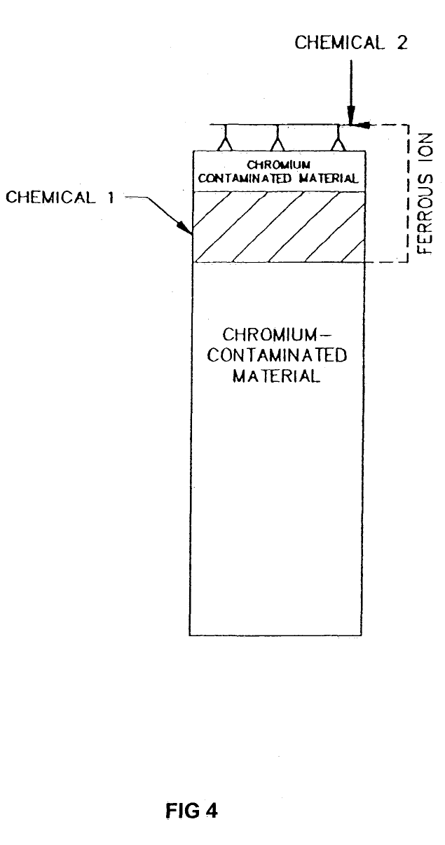

In yet another embodiment of the present invention, depicted in FIG. 4, ferrous sulfate is brought into contact with chromium-contaminated waste to produce a ferric salt solution that is then brought into contact with iron pyrite to enhance the oxidation of the iron pyrite.

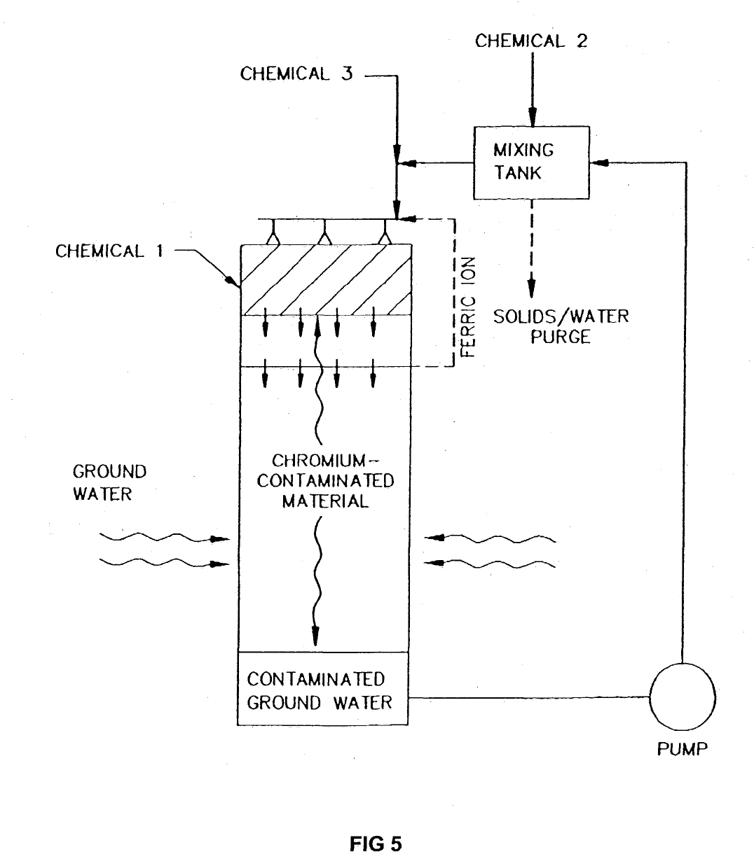

In another embodiment, shown in FIG. 5, iron pyrite in fluid communication with the chromium-contaminated waste is oxidized by ferric sulfate. The ferrous sulfate and sulfuric acid produced by oxidation contact the waste, whereupon the ferrous sulfate is oxidized to ferric sulfate. A portion of the ferric sulfate can be withdrawn from the treated waste and recycled onto the iron pyrite, thereby promoting pyrite oxidation and chromium-contaminated waste stabilization.

In still another embodiment, the iron pyrite oxidation may be catalyzed microbiologically using an iron-oxidizing microorganism such as bacteria, for example Thiobacillus ferrooxidans, to generate the ferrous sulfate/sulfuric acid mix for stabilizing chromium. Alternatively, iron pyrite oxidation may be catalyzed by passing humid air through the iron pyrite layer or by adding at least one chemical oxidant such as a peroxygen compound. The peroxygen compound can be a peroxide (e.g., hydrogen peroxide, calcium peroxide, magnesium peroxide and the like), a persulfate, permanganate, perborate, percarbonate and the like.

In a further embodiment of the present invention, the alkaline chromium-contaminated waste may be treated with sufficient amounts of ferrous sulfate and sulfuric acid to neutralize the surface alkali and pore water and to stabilize readily leached hexavalent chromium. Slow but controlled addition of ferrous sulfate/sulfuric acid may then be applied to the waste matrix via controlled oxidation of iron pyrite to stabilize the slowly release alkalinity and leached chromium.

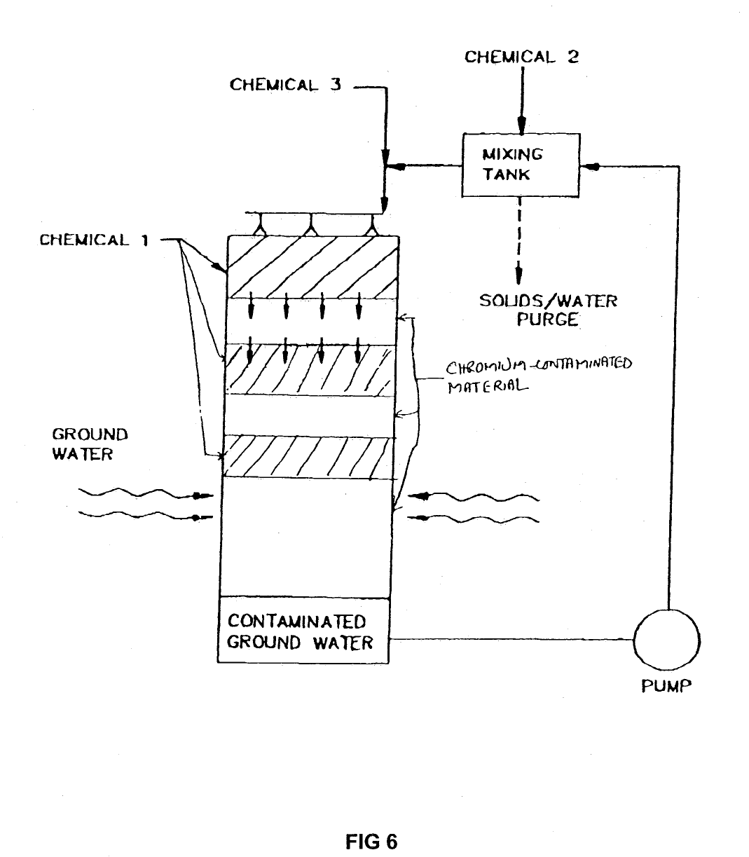

In yet another embodiment of the present invention, an aqueous slurry of iron pyrite can be injected at various depths of a waste column to create alternating iron pyrite and waste layers (FIG. 6). In a preferred mode of operation, the top iron pyrite layer may first be oxidized to ferrous sulfate and sulfuric acid, thereby stabilizing chromium-contaminated waste right below the top pyrite layer and producing ferric ions. The ferric ions thus produced can flow downward into the next pyrite layer to produce ferrous sulfate and sulfuric acid, continuing the cycle of pyrite oxidation and waste stabilization, thereby expediting the overall chromium-contaminated waste stabilization process.

The iron pyrite oxidation step can proceed at a slow rate and can generate ferrous sulfate and sulfuric acid in amounts insufficient for use in treating the COPR waste. The oxidation reaction rate can be limited by an inadequate supply of input ferric ions. To address this need, one can simultaneously or separately oxidize ferrous ions to generate additional ferric ions in a side reaction. In a preferred embodiment, a side reactor can employ, e.g., a microbiological catalyst such as an iron-oxidizing bacterium, such as Thiobacillus ferrooxidans. The ferric ions can be used to oxidize iron pyrites, as above, to ferrous sulfate and sulfuric acid. Iron pyrite oxidization by ferric sulfate can be represented as follows:

7Fe₂(SO₄)₃+FeS₂+8H₂O→15FeSO₄+8H₂SO₄.

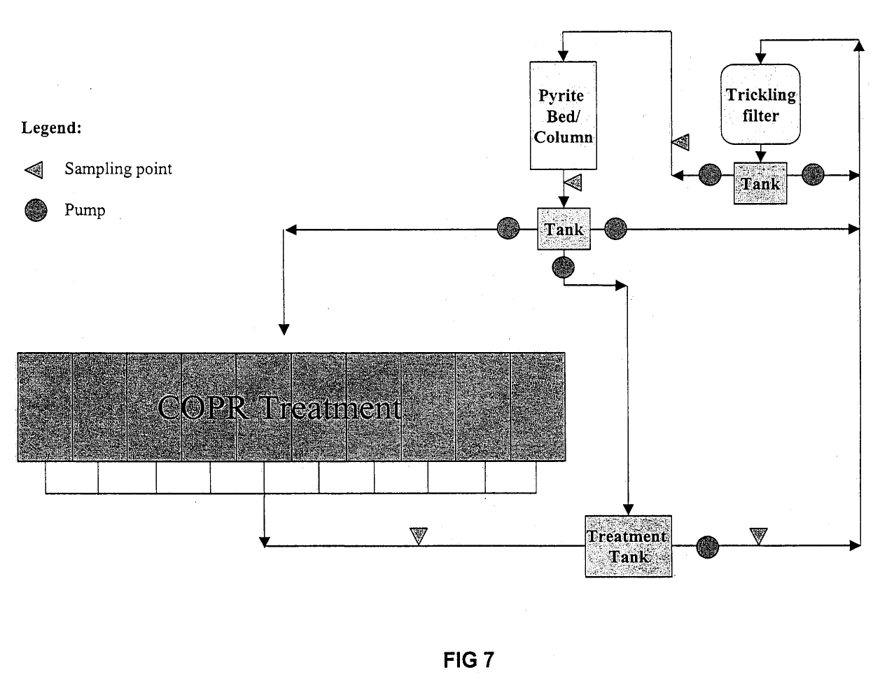

As desired, a fraction of the ferrous sulfate thus produced can be recycled back to the side reactor to convert to the ferric form while another fraction can be used for COPR treatment. An embodiment of this treatment approach is shown in FIG. 7.

Waste stabilization with ferrous sulfate and sulfuric acid may cause significant changes in the geotechnical characteristics of the disposed waste. Generally, the permeability of the treated waste will be lower in comparison to that of the untreated waste. However, the unconfined compressive strength (UCS) may be reduced. As necessary, a low concentration of pozzalonic material (e.g., ground iron slag, silicate such as Olivine, etc.) is added (to between about 5 and 20% by weight) to the treated waste to improve (raise) the UCS of the stabilized waste.

When the treatment solution containing acidic ferrous sulfate and sulfuric acid contacts the alkaline COPR particulate waste (which contains significant quantities of calcium oxide and calcium hydroxide), CaSO₄ forms and deposits as a protective layer on particle surfaces. The CaSO₄ layer impedes access of the acidic reactants to unstabilized hexavalent chromium in the inner reaches of the particles. While treatment may appear to be complete if no chromium is released from the particles, chromium can, mobilize over time through the CaSO₄ layer, necessitating further stabilizing treatment. On the other hand, when the pH of the treatment solution is unacceptably low (e.g., below about pH 1), both the CaSO₄ layer and the stabilized trivalent chromium are chemically solubilized, and mobile trivalent chromium can be undesirably released. Accordingly, the CaSO₄ protective layer does not have to be maintained intact, but should stay in the solid phase.

It is herein disclosed that a preferred practice of the invention balances CaSO₄ build-up with controlled physical (e.g., shearing, grinding or pulverizing) or chemical disintegration of CaSO₄. The preferred practice moderates access by ferrous sulfate and sulfuric acid to the chromium in the waste, while maintaining the stabilized trivalent chromium and the CaSO₄ in the solid phase. Accordingly, it is preferred to contact the particulate waste with a treatment solution that comprises ferrous sulfate and sulfuric acid where the solution has a pH above about 1, such as a solution of 0.2-1% of each component (by weight). At these concentrations, the reactants in the treatment solution can diffuse through the protective CaSO₄ layer without substantially solubilizing the treated waste matrix (preferably no more than about 5% solubilized), while the acid in the solution can react with the COPR waste to yield a stabilized non-mobile trivalent chromium.

Even at a solution pH of about 1, the treatment solution may diffuse slowly through the protective CaSO₄ layer and unreacted COPR may persist in the core of waste particles having particle size too large to permit diffusion to the deepest core portion. Under these circumstances, the partially stabilized COPR waste can be physically disturbed to disrupt the protective CaSO₄ layer (e.g., by shearing, grinding, or pulverizing) and then contacted again with FeSO₄ and H₂SO₄. This process can continue until the COPR waste is completely reacted with the treatment solution.

To determine the COPR stabilization endpoint the treated COPR waste can be analyzed by TCLP-chromium or other induced leaching procedures (SPLP, ASTM water leach etc.) A simpler and a less expensive measure of long-term treatability is to track the acid neutralization capacity (ANC) of the waste. Since the waste is characterized by high lime content, and, therefore, has a high ANC value, neutralization of this lime along with the conversion of hexavalent chromium to trivalent chromium is essential for waste stabilization. A near-neutral ANC value of the treated waste, after treatment with the treatment solution, indirectly indicates complete waste stabilization.

Another benefit of the preferred, moderated process is that it can reduce or prevent channeling, the phenomenon whereby the acidic stabilization chemicals solubilize the waste matrix and force liquid channels of unreacted stabilization chemicals to extend along paths of least resistance to the bottom of a COPR waste mass or column being stabilized.

Additionally and advantageously, when the ferrous sulfate and sulfuric acid react with the alkaline COPR waste to form CaSO₄, the potential for heaving, a subsurface upswelling of a COPR waste mass or column at a stabilization site, is reduced or prevented. Heaving typically occurs when calcium oxide and calcium hydroxide present in COPR waste react with ambient CO₂ gas to form CaCO₃, which has a higher molecular volume than the reactants. In the methods of the present invention, on the other hand, the calcium compounds react with the ferrous sulfate and sulfuric acid to yield CaSO₄, which does not react with CO₂ and heaving cannot occur.

The present invention will be further understood upon consideration of the following non-limiting examples.

### EXAMPLE

An alkaline chromium ore processing residue (COPR) waste containing approximately 3.70 percent by weight chromium and 55 percent by weight lime (expressed as Ca(OH)₂) was TCLP toxic for chromium with an untreated screening TCLP chromium concentration of 140 mg/L. The waste was treated (first treatment) with 10 percent by weight ferrous sulfate heptahydrate (FeSO₄.7H₂O) and 5 percent by weight ferric sulfate (Fe₂(SO₄)₃.xH₂O) and was analyzed for screening TCLP chromium. The screening TCLP chromium concentrations with varying elapsed time after treatment were as follows:

| TIME ELAPSED | SCREENING |
|---|---|
| AFTER FIRST | TCLP-CHROMIUM |
| TREATMENT (days) | (mg/L) |
| 0 | 0.8 |
| 3 | 2.6 |
| 7 | 7.0 |
| 28 | 14.2 |

Although the treated waste was non-TCLP toxic for chromium immediately after treatment, the screening TCLP chromium concentrations increased over time and exceeded the RCRA hazardous waste threshold TCLP concentration of 5 mg/L after 7 days. The screening TCLP chromium concentration of the treated waste continued to increase with increased elapsed time. Evidently, the first treatment provided a temporary treatment for control of the chromium leachability of the waste.

The above treated waste after 7 days of elapsed time was further treated (second treatment) with approximately 10 percent by weight sulfuric acid and 25 percent by weight ferrous sulfate heptahydrate. The screening TCLP chromium concentrations after the second treatment were as follows:

| TIME ELAPSED | SCREENING |
|---|---|
| AFTER SECOND | TCLP- |
| TREATMENT | CHROMIUM |
| (days) | (mg/L) |
| 7 | 0.9 |
| 21 | 0.6 |

The waste after the second treatment did not increase in toxicity as shown by the non-TCLP toxic concentrations of chromium at both the 7-day and 21-day screening TCLP analysis.

The present invention is not intended to be limited to the foregoing, but to encompass all such modifications and variations as fall within the scope of the appended claims.

We claim:

1. A method for reducing mobile hexavalent chromium to non-leachable trivalent chromium in alkaline chromium-contaminated particulate matter or associated pore water, the method comprising the steps of:
contacting a source of hexavalent chromium with ferrous ions to produce ferric ions;
oxidizing iron pyrite with ferric ions to produce a treatment solution that comprises ferrous sulfate and sulfuric acid, at least a portion of the ferric ions being obtained by microbiological catalytic oxidation of ferrous ions; and
contacting the alkaline chromium-contaminated particulate matter or the pore water with the treatment solution for a time sufficient to convert ferrous sulfate into ferric sulfate and to reduce mobile hexavalent chromium to trivalent chromium in the particulate matter,
wherein ferrous sulfate produced by oxidizing iron pyrite is a source of ferrous ions in the first contacting step.

2. A method as claimed in claim 1 wherein the iron pyrite is in fluid communication with the alkaline chromium-contaminated particulate matter or the pore water.

3. A method as claimed in claim 1 wherein the source of hexavalent chromium is groundwater that comprises hexavalent chromium and wherein the first contacting step comprises the step of contacting the groundwater with ferrous ions to produce a treated groundwater that comprises ferric ions.

4. A method as claimed in claim 1 wherein the source of hexavalent chromium is a leachate that comprises hexavalent chromium and wherein the first contacting step comprises the step of contacting the leachate with ferrous ions to produce a treated leachate that comprises ferric ions.

5. A method as claimed in claim 10 wherein the ferric sulfate is a source of ferric ions for the oxidizing step.

6. A method as claimed in claim 1 wherein the oxidizing step comprises the step of adding exogenous ferric salt to the iron pyrite.

7. A method as claimed in claim 3, wherein the first contacting step further comprises the step of separating the ferric ions from particulate solids in the treated groundwater.

8. A method as claimed in claim 1, wherein the iron pyrite is oxidized ex situ.

9. A method as claimed in claim 8, wherein the ex situ oxidation is selected from the group consisting of wet oxidation and wet air oxidation.

10. A method as claimed in claim 1 wherein the oxidizing step comprises the step of contacting the iron pyrite with ferric ions.

11. A method as claimed in claim 1 wherein the oxidizing step comprises the step of contacting the iron pyrite with a microbiological catalyst.

12. A method as claimed in claim 11 wherein the microbiological catalyst is an iron-oxidizing bacterium.

13. A method as claimed in claim 12 wherein the iron-oxidizing bacterium is Thiobacillus ferrooxidans.

14. A method as claimed in claim 1 wherein the oxidizing step comprises the step of passing humid air through the iron pyrite.

15. A method as claimed in claim 1 wherein the oxidizing step comprises the step of contacting the iron pyrite with a chemical oxidant.

16. A method as claimed in claim 15 wherein the chemical oxidant is a peroxygen compound.

17. A method as claimed in claim 16 wherein the chemical oxidant is selected from the group consisting of a peroxide, a persulfate, a permanganate, a perborate, and a percarbonate.

18. A method as claimed in claim 17 wherein the chemical oxidant is a peroxide selected from the group consisting of hydrogen peroxide, calcium peroxide, and magnesium peroxide.

19. A method as claimed in claim 1 wherein the mobile hexavalent chromium treated in the method is in particulate matter, the method further comprising the step of increasing the unconfined compressive strength of the particulate matter.

20. A method as claimed in claim 19 wherein the unconfined compressive strength is increased by adding a low concentration of a pozzalonic material to the particulate matter.

21. A method as claimed in claim 20 wherein the pozzalonic material is selected from the group consisting of a ground iron slag and a silicate.

22. A method as claimed in claim 4 wherein the first contacting step further comprises the step of separating the ferric ions from particulate solids in the treated leachate.

23. A method as claimed in claim 1 wherein the treatment solution has a pH above about 1.

24. A method as claimed in claim 1 further comprising the step of measuring acid neutralization capacity of the particulate matter or the pore water after contact with the treatment solution.

25. A method as claimed in claim 1 further comprising, after the step of contacting the particulate matter or the pore water with the treatment solution, the steps of:
disrupting a CaSO₄ layer formed on the particulate matter in the contacting step to produce disrupted particulate matter; and
contacting the disrupted particulate matter with the treatment solution.

26. A method as claimed in claim 25 wherein the disrupting step comprises a step selected from the group consisting of shearing, grinding and pulverizing the particulate matter.

27. A method for reducing mobile hexavalent chromium to non-leachable trivalent chromium in alkaline chromium-contaminated particulate matter or associated pore water, the method comprising the steps of:
contacting a source of hexavalent chromium with ferrous ions to produce ferric ions;
oxidizing iron pyrite with ferric ions to produce a treatment solution that comprises ferrous sulfate and sulfuric acid;
contacting the alkaline chromium-contaminated particulate matter or the pore water with the treatment solution for a time sufficient to convert ferrous sulfate into ferric sulfate and to reduce mobile hexavalent chromium to trivalent chromium in the particulate matter; and
measuring acid neutralization capacity of the particulate matter or the pore water after contact with the treatment solution,
wherein ferrous sulfate produced by oxidizing iron pyrite is a source of ferrous ions in the first contacting step.

28. A method for reducing mobile hexavalent chromium to non-leachable trivalent chromium in alkaline chromium-contaminated particulate matter or associated pore water, the method comprising the steps of:
contacting a source of hexavalent chromium with ferrous ions to produce ferric ions;
oxidizing iron pyrite with ferric ions to produce a treatment solution that comprises ferrous sulfate and sulfuric acid;
contacting the alkaline chromium-contaminated particulate matter or the pore water with the treatment solution for a time sufficient to convert ferrous sulfate into ferric sulfate and to reduce mobile hexavalent chromium to trivalent chromium in the particulate matter;
disrupting a CaSO₄ layer formed on the particulate matter in the contacting step to produce disrupted particulate matter; and
contacting the disrupted particulate matter with the treatment solution,
wherein ferrous sulfate produced by oxidizing iron pyrite is a source of ferrous ions in the first contacting step.

29. A method as claimed in claim 28 wherein the disrupting step comprises a step selected from the group consisting of shearing, grinding and pulverizing the particulate matter.
